(19) United States
(12) Patent Application Publication
(10) Pub. No.: US 2008/0128482 A1
(43) Pub. Date: Jun. 5, 2008

(54) Drug dispense, identification, labeling and the system of inspection

(75) Inventors: Chao-Hsiang Chen, Ping-Cheng City (TW); Yi-Jui Chang, Ping-Cheng City (TW); Mei-Limg Chen, Ping-Cheng City (TW)

Correspondence Address: TROXELL LAW OFFICE PLLC, SUITE 1404, 5205 LEESBURG PIKE, FALLS CHURCH, VA, 22041, US

(73) Assignee: KO DA PHARMACEUTICAL CO., LTD.

(21) Appl. No.: 11/826,379

(22) Filed: Jul. 13, 2007

(30) Foreign Application Priority Data
Aug. 24, 2006 (TW) 095131059
Aug. 24, 2006 (TW) 095131060

(51) Int. Cl. G06F 17/00; G06K 19/06

(52) U.S. Cl. 235/375; 235/494

(57) ABSTRACT

This system of identification and labeling is set on the container or package of drugs and contains drug identification units for the identification of the drug name, including identification units of manufacturing batch number and time. The identification unit of manufacturing batch number is used for the identification of the batch number of the drug while the time identification unit for the identification of the expiry date of the drug, quickly making the consumers understanding the manufacturing batch number and the expiry date of the drug through reading the identification labels so as to effectively control the quality and conservation of drugs.

### BACKGROUND OF THE INVENTION

(a) Field of the Invention

This invent is related to the dispense, identification and labeling of drugs, which can make possible quick understanding of the manufacturing batch number and expiry date of drugs so as to effectively control the quality and conservation of drugs, and can be used in particular in the dispense of drugs in hospitals, clinics and so on, with the advantages of reducing mistakes in drug dispense, dosage or overdue drugs.

(b) Description of the Prior Art

The goods (e.g. food) sold at the super markets and convenient shops (referred to shops thereafter) and those sold at the drug stores (e.g. drugs) have been packed with attachment of trade marks, and the account is settled by using the bar code reader which connects with the end instruments like money-collecting machine. At the same time, it can also be used to manage the materials of marketing and goods. The labels attached to the goods are printed by the filemark printer which is located in other preparing areas (the processing factories of the shops or pharmaceutical factories) and is connected with computers and so on. As demonstrated in FIG. 1, this goods filemark has on it the commodity, expiry date (or consumption deadline), manufacture date as well as the bar code to record the drug identification unit and so on.

The bar code attached to common goods is JAN code, whose system and digit are standardized according to the regulations. Moreover, below the bar code, there is the character code corresponding to the bar code. The filemark bar code printed in FIG. 1 is the standard JAN code, and this bar code is usually composed of a 13-digit code, including the first two digits indicating the country code, the 5 digits from the third to the seventh indicating the manufacturing code, the 5 digits from the eighth to the twelfth indicating the commodity code, and the thirteenth indicating the checking unit.

In addition, the inspection of the goods in the stock of the shops or drug stores is conducted by the personnel in charge by accounting the quantity of the goods. For goods with special care related to the freshness, the consumption deadline printed on the filemark attached to the goods is checked up for the management of quality. Only because the goods are managed through manual work, mistakes may appear regarding the consumption deadline so that goods which are overdue in the expiry date are still put on the shelf.

Even in the case of goods which have passed the consumption deadline without notice, the operators of the end instruments like money-collecting machines will settle the account of shopping by using the bar code reader to read the bar code on the filemark, whereas the bar code on the filemark has the display of manufacture code, drug identification unit and so on rather than the consumption deadline and time. Therefore, if the operators of the end instruments have not the awareness of the expiry date, the goods which have exceeded the shelf life may be sold to the consumers carelessly, especially those food whose freshness needs to be maintained (sandwich or fast food), possibly resulting in food poisoning, or those drugs whose effectiveness must be maintained, possibly resulting in less effectiveness of the drugs. Therefore, these goods must be strictly managed. If goods which have passed the consumption deadline are sold, the risks are very big.

When food or drug is being manufactured, the food or drug finished in every batch may be a little different because the used content or the drug components are different. If some food or drug has some abnormality after the consumers have used them and the whole batch of the food or drug need to be reclaimed, it is difficult to recover them because you do not know where these food or drug have gone.

### SUMMARY OF THE INVENTION

The purpose of the present invention is to make possible quick understanding of the manufacturing batch number and expiry date of drugs so as to effectively control the quality and conservation of drugs, and can be used in particular in the dispense of drugs in hospitals, clinics and so on, with the advantages of reducing medical mistakes in drug dispense, dosage or overdue drugs.

To achieve the purpose, the identifying symbols of the present invention contain a drug identification unit (or goods code), a manufacturing batch number identification unit (or manufacturing batch number code) and a time identification unit (or time code). The manufacturing batch number identification unit can help identify the manufacturing batch number while the time identification unit can help identify the drug expiry date so that the consumers, after the reader has read the identification symbols, can quickly understand the manufacturing batch number and the expiry date so as to effectively control the quality of the drugs.

### BRIEF DESCRIPTION OF THE DRAWINGS

FIG. 1 is a schematic diagram of the filemark attached to all drugs of the prior art.

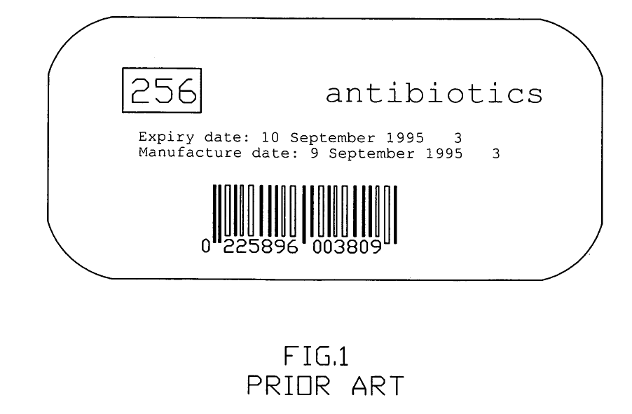

FIG. 2 is a structural schematic diagram of identification labeling attached to the drugs in this invention.

FIG. 3 is a structural schematic diagram of the identification labeling applied to the drug administration system in this invention.

FIG. 4 is a structural schematic diagram of the drug containers or package in this invention.

FIG. 5 is a flow-sheet diagram of receiving the prescription by the database in this invention.

FIG. 6 is a flow-sheet diagram of drug preparation for the patient in this invention.

FIG. 7 is a flow-sheet diagram of handing over the drugs to the patient in this invention.

### DETAILED DESCRIPTION OF THE PREFERRED EMBODIMENTS

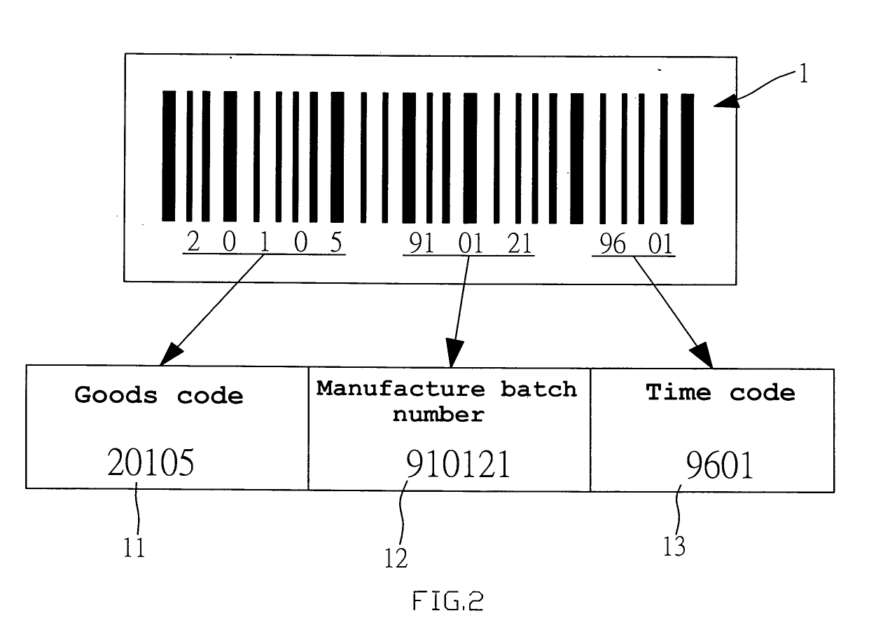

The present invention has the whole identification symbols shown in FIG. 2. An identification symbol 1 contains a drug identification unit 11, a manufacturing batch number identification unit 12 and the time identification unit 13. The drug identification unit 11 can help identify the drug name, the manufacturing batch number identification unit 12 can help identify the manufacture batch number of the drug, and the time identification unit 13 can help identify the expiry date of the drug. In FIG. 2, the identification symbol 1 can be the bar code, 2-dimensional bar code, symbols or RFID.

Furthermore, this identification symbol 1 contains the manufacturing batch number identification unit 12 as shown in FIG. 2. The manufacturing batch number identification unit 12 can help identify the manufacturing batch number of the drug, and if this batch of drug needs to be reclaimed, the drug with the same manufacturing batch number identification unit 12 can be completely reclaimed in the shortest possible time.

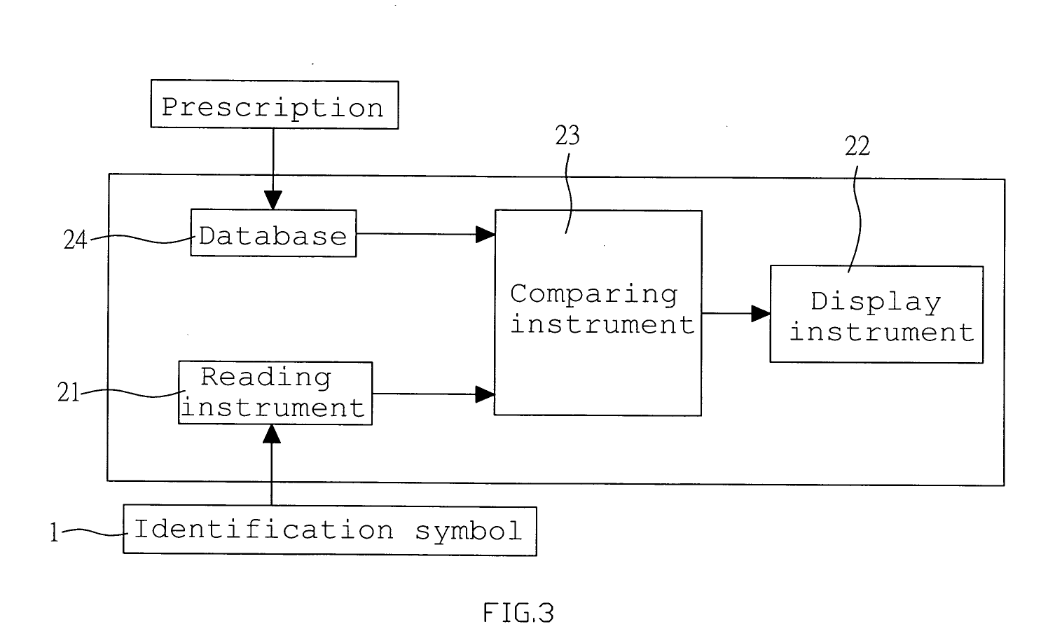

The identification symbols 1 of this invent can be applied to the drug containers or packages sold at common drug stores with an inspection system matched as shown in FIG. 3, including a reading instrument 21 and a display instrument 22. The reading instrument 21 can be a bar code reader for the reading of the identification symbol 1, and the corresponding data may be displayed on the display instrument 22. The drug name, manufacturing batch number and the drug expiry date can all be shown on the display instrument 22 so as to understand if the drug is overdue or not. Furthermore, the inspection system can have a comparing instrument 23 to be set up so as to judge the effective deadline of the drug. If the drug is overdue, it can be shown on the display instrument 22. For example, the comparing instrument 23 can compare the date of the consumption with the drug expiry date, and when the drug expiry date is overdue, the display instrument 22 can give out an alarm which can be an image or a sound. In this way, when the quality of drug is processed, whether the drug is overdue or not can be made known quickly, and the operators of the end instruments like the money-collecting machine will also know whether the drug is overdue or not. Therefore, the drug quality can be maintained better, and it can be ensured that the drug overdue will not be sold to consumers. When the drug stores conduct drug dispense according to the prescription, a database 24 can be equipped for connection with the reading instrument 21. The database 24 stores information of drug categories and details, and the prescription can be input or delivered to the database. When the pharmaceutist is preparing drug dispense, the reading instrument 21 can read the identification symbols 1 on the drug while the comparing instrument 23 can compare if the drugs have the same content and dosage with the prescription. If there is any difference, it can be shown on the display instrument 22 which can give out an alarm when the drug dosage inconsistent. If it is consistent, the drug dispense and inspection is completed.

The methods for drug dispense and inspection include at least the following procedures:

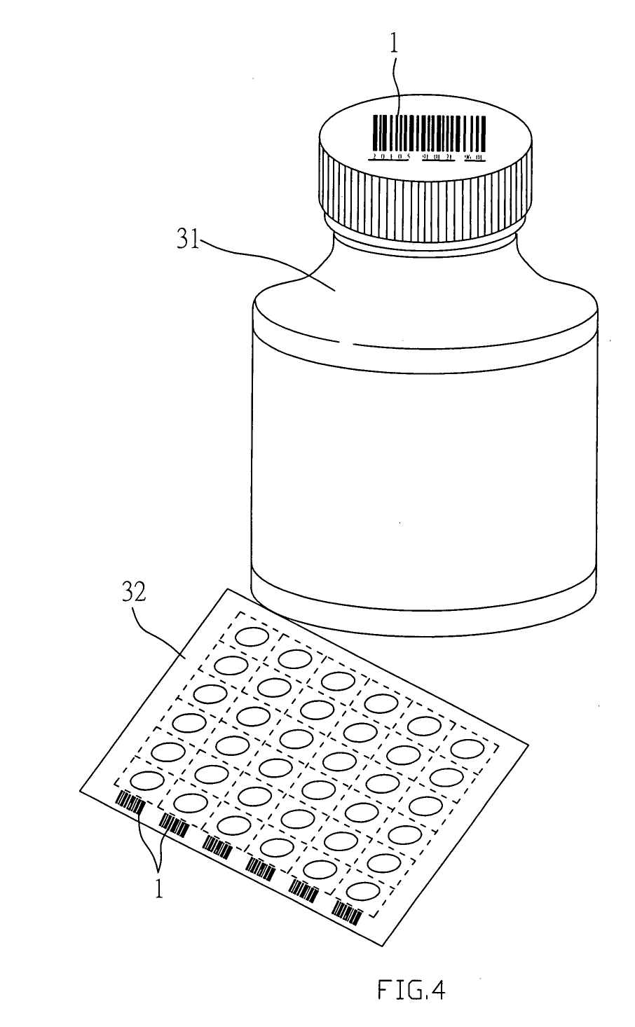

Step one: The identification symbol 1 corresponding to the drug is set on a drug container 31 or a package 32, as shown in FIG. 4.

Step two: After the doctor has diagnosed the patient's disease and determined the drug category, dosage and administration duration of the drug, the patient's data (such as the name, identity number or health care card number) and the drug data (such as the drug category, dosage and administration duration) are input and the prescription or the medical record of the patient is generated.

Step three: The doctor's prescription or the medical record of the patient is input or delivered to the database, with the input manner as keyboard or imaging identification system and the delivery manner as wire or wireless means. After receipt of the prescription by the database, the database reads the drug data including the prescription's drug category, dosage and administration duration. If the prescription or the medical record contains two or more than two drugs, the database decides whether these two or more than two drugs are contraindicated if used together based on the information of all drugs stored in the database. If the two or more than two drugs are contraindicated if used together, the information is shown on the display instrument.

Step four: After the prescription or the medical record is sent to the dispensarium or drug assigning room, medical professionals dispense the drugs according to the prescription or medical record, or according to the drug data shown on the display instrument after the prescription or the medical record is sent to the database. First, take out the needed amount of the prescribed drugs, make the reading instrument (such as the bar code reader) read the identification symbols (such as the bar code) on the drug containers (if the drug is liquid, the container will be ampere, small glass battle and so on) or the package (if the drug is tablet and capsules, the package is PTP package and so on), and consequently, the identification data (including the drug category, manufacture batch number and the expiry date) of the drug are generated.

Step five: The comparing instrument is designed to compare the drug data on the prescription or the medical record received by the database with the identification data acquired from the identification symbols on the container or package, so as to judge whether they are the same or not. If the drug category is not consistent, it can be displayed on the display instrument. In the same way, the administration duration of the dispensed drug can be judged to exceed the expiry date of the drugs. If the duration has exceeded the drug expiry date, it can be shown on the display instrument, too.

Step six: If the drug category is consistent and the drug dosage is dispensed according to the prescription, the counting equipment can be used for the dispense. The counting equipment can be an electronic scale or an arithmometer. The numerical values calculated by the counting equipment can be compared with the drug data (namely the drug dosage) to see if they are consistent. If they are not consistent, it can be shown on the display instrument. If they are consistent, the drug dispense and inspection will be completed.

The drug information stored in the database can be the names of all sorts of drugs, proper information regarding the combined use of drugs, the permissible dosage every time or within a certain amount of time, the time interval from one dispense to the next dispense, the dispense methods, the limit of dispense, announcements and so on. Therefore, when the prescription or medical record is input or delivered to the database, the drug information can be checked with those in the database to see if the drug data on the prescription or the medical record is correct or not. Moreover, the database can also read the patient information on the prescription (such as name, identity card number or health care card number) so as to confirm the patient for storage, while at the same time, the drug information on the prescription and the drug identification data consistent with the drug information are recorded in the patient data.

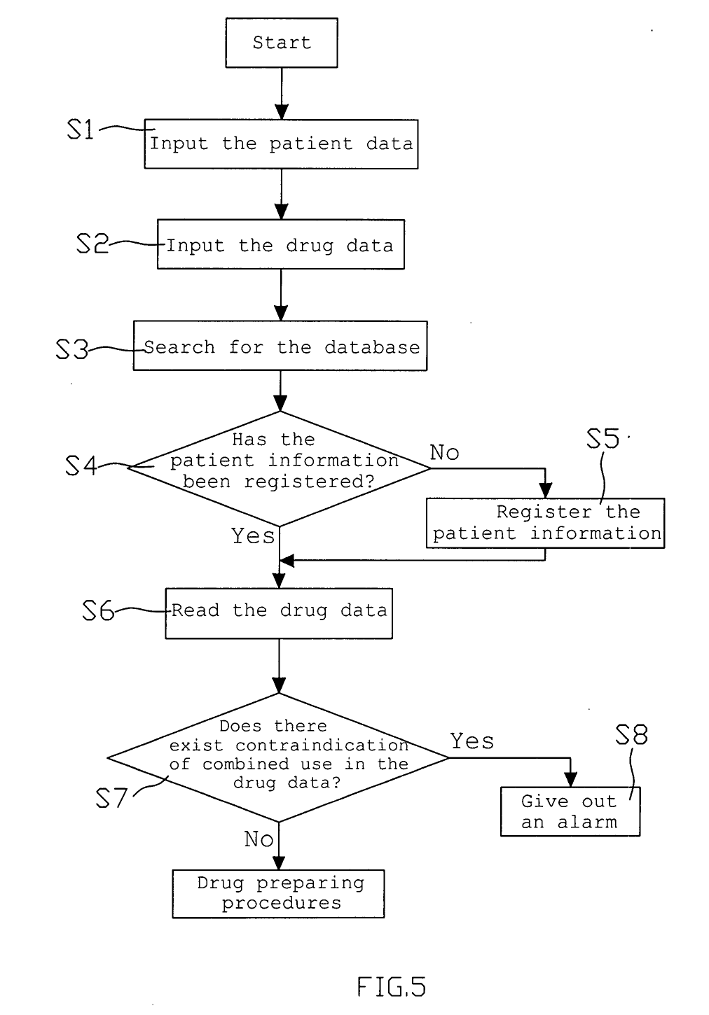

As shown in FIG. 5 is the flow-sheet steps for the database to receive the prescription. The doctor inputs the patient's data, including at least the patient's name, identity card number or health care card number (S1), and the data of the drugs used by the patient, including at least the drug category, dosage and administration duration (S2). These data are transferred to the database by using the keyboard or the imaging identifying system or using wire or wireless transforming methods, and searching is performed in the database (S3).

It is first judged whether this patient is registered or not (S4), and if it is not registered, register the patient's data (S5). If this patient is registered, the database reads the drug data (S6), and judges and compares whether there are two or more than two drugs existing in the drug prescription which are contraindicated if used together (S7).

If there are two or more than two drugs which are contraindicated if used together, the database gives out an alarm of image or sound through the display instrument (S8) and the processing is ended. If there are no two or more than two drugs which are contraindicated if used together (S7 is no), the database displays the drug data on the display instrument and carries out drug preparation.

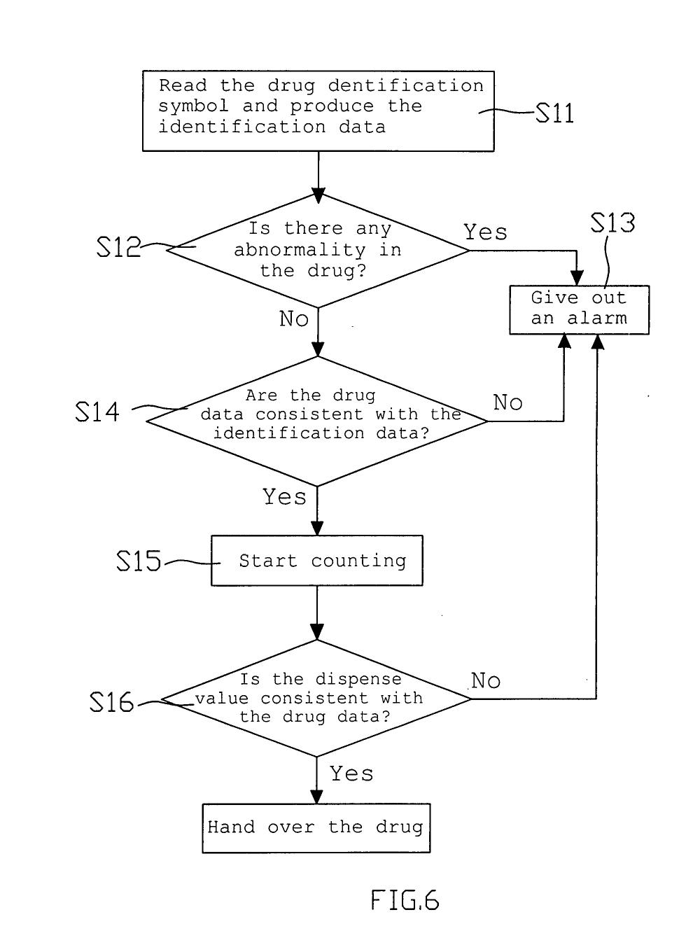

As shown in FIG. 6, in the dispensarium or the drug assigning room, medical professionals prepare the patient's drugs according to the prescription or the medical record.

Medical professionals dispense the drugs according to the prescription or medical record, or according to the drug data shown on the display instrument. First, take out the needed amount of the prescribed drugs, make the reading instrument (such as the bar code reader) read the identification symbols (such as the bar code) (S11) on all the drug containers or the package, and consequently, the identification data of the drugs are generated based on the identification symbols (including drug category, manufacture batch number and expiry date). By comparing the drug's expiry date and the current date, it can judged whether the drug is abnormal or not (such as exceeding the expiry date) (S12). If the drug is overdue, the display instrument gives out an alarm of an image or a sound (S13). If the drug is not overdue (S12 is no), the comparing instrument compares the identification data of the drug with the drug data received by the database to see whether they are the same (S14), and when they are the same, the counting steps for drug dispense are carried out. If they are not consistent, the display instrument gives out an alarm of an image or a sound (S13).

The counting equipment connected with the comparing instrument is used to count the drugs which are judged with no mistakes (S15). The counting equipment can be an electronic scale or an arithmometer. When the drugs are tablets or particles, the counting equipment can be applied. If the drugs are powder or liquid, the electronic scale can be used. Put the assigned amount of the prescribed drug into the counting equipment which displays whether or not the dispensed drug values are in accordance to the drug data received by the database (S16). If the numerical values are not consistent with the drug dosage or the error value has been exceeded, the display instrument gives out an alarm of an image or a sound (S13). If the values are consistent with the drug dosage or the error has not be exceeded (S16 is no), the dispensed drugs can be handed over to the patient, and at the same time, the correct drug data are registered and stored in the database corresponding to the patient data.

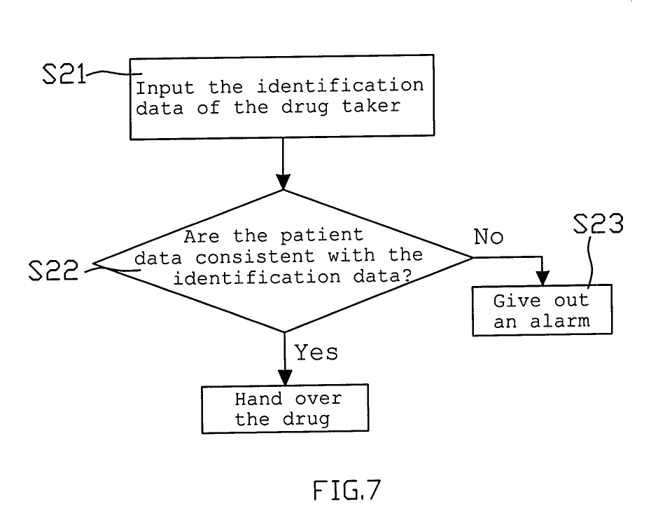

FIG. 7 shows the flow-sheet steps in which the dispensed drugs are handed over to the patient by the medical professionals. At the drug assigning room, the identification data of the drug taker are input (S21), and the identification data can be the name, identity card number or the health care card number of the drug taker. After the identification data are input, the comparing instrument is used to compare the patient data received by the database with the identification data of the drug taker to see whether they are consistent or not (S22). If they are consistent, the drugs can be handed over to the patient and the processing is over, and if they are not consistent, the display instrument gives out an alarm of an image or a sound (S23) and the drugs must not be handed over.

In general, the identification symbols of this invent can be applied for the administration of drug marketing and drug storage, with the following advantages:
1. After the doctor makes the prescription or the medical record, all the following drug information can be checked up, including contraindication of drugs if used together in the prescribed drugs, the permissible dosage every time or within a certain amount of time, the time interval from one dispense to the next dispense, dispensing methods, the limit of the dispense, announcements and so on.
2. Whether or not the drug categories and dosages prepared by medical professionals are consistent with those indicated in the prescription or medical record.
3. Whether or not the drugs prepared by medical professionals exceed the expiry date, or the drugs indicated in the prescription or the medical record exceed the drug expiry date.
4. When the drugs are handed over to the patient, the identity of the drug taker is ascertained so as to avoid mistakes of handing over the incorrect drugs.
5. After the drugs are given to the patient, the drug identification data are stored together with the patient data. If the patient has any abnormal reaction to the drug, similar problems are checked up as to whether they exist in the drugs of the same manufacture batch number with that of the drug causing abnormal reactions.
   As stated above, this invent provides a more feasible way of identification symbol, and therefore, a patent of new type is applied. The above enforcement description and the figure demonstration are the better cases of enforcement and do not confine this invention. Therefore, all those inventions similar to this invention in structure, equipment, characteristics and so on fall within the purpose of this invention and the scope of this patent application and protection.

I claim:

1. An identification symbol for drug dispense and inspection placed on a container or a package of drugs, comprising:
a drug identification unit;
a manufacturing batch number identification unit identifying a manufacture batch number of the drugs;
a time identification unit identifying an expiry date of the drugs.

2. The identification symbol as claimed in claim 1, wherein the drug identification unit can help identify the drug name.

3. The identification symbol as claimed in claim 1, wherein the identification symbol can be bar code, symbol, RFID or 2-dimensional bar code.

4. The identification symbol as claimed in claim 1, wherein a reading instrument can be used for reading of the identification symbol.

5. The identification symbol as claimed in claim 4, wherein the reading instrument can be connected with a display instrument which can show the corresponding data to the reading of the identification symbol on the display instrument.

6. The identification symbol as claimed in claim 5, wherein the reading instrument can be further connected with a comparing instrument for the judgment of the drug expiry date; if the drug is overdue, it can be shown on the display instrument.

7. The identification symbol as claimed in claim 6, wherein the display instrument can give out an alarm when the drug has exceeded the expiry date.

8. The identification symbol as claimed in claim 6, wherein the reading instrument can be further connected with a database for an input of a prescription; when a pharmaceutist is preparing the drugs, the reading instrument will read the identification symbol and the comparing instrument will compare the drugs with the content of drugs in the prescription, including the dosage to be used, to see if the drugs are consistent with each other; if the drugs are not consistent, it can be shown on the display instrument.

9. The identification symbol as claimed in claim 8, wherein the display instrument can give out an alarm when the dosage is not consistent.

10. The identification symbol as claimed in claim 7, wherein the alarm can be an image or a sound.

11. The identification symbol as claimed in claim 9, wherein the alarm can be an image or a sound.

12. A system of drug dispense and inspection comprising:
a database which store drug categories and information related to drugs and can receive a prescription and read drug information on the prescription; the drug information includes at least the drug category and dosage;
a reading instrument connected with the database which reads identification data of the drugs according to a identification symbol on a drug container or package;
a comparing instrument to compare the drug information with the identification data;
a display instrument to show the comparing results acquired from the comparing instrument.

13. The system of drug dispense and inspection as claimed in claim 12, wherein after the database has read the drug information on the prescription with two or more than two drugs recorded, the system further can judge whether or not these drugs are contraindicated if used together; if the drugs are contraindicated if used together, a contraindicated information will be shown on the display instrument.

14. The system of drug dispense and inspection as claimed in claim 12, wherein the identification symbol includes a goods code, a manufacturing batch number code and a time code; a manufacturing batch number of the drug can be gained from the manufacturing batch number code while the time code indicates the expiry date of the drug.

15. The system of drug dispense and inspection as claimed in claim 12, wherein after the reading instrument has read the identification data of the drugs, the system can further judge whether or not the drugs are overdue, and if the drug is overdue in expiry date, an overdue information can be shown on the display instrument.

16. The system of drug dispense and inspection as claimed in claim 12, wherein the comparing instrument can compare the drug expiry date with the drug information so as to judge whether the drug's administration duration has exceeded the drug expiry date; if it has exceeded the drug expiry date, it can be shown on the display instrument.

17. The system of drug dispense and inspection as claimed in claim 12, wherein the display instrument can give out an alarm when the compared results are not consistent.

18. The system of drug dispense and inspection as claimed in claim 17, wherein the alarm can be an image or a sound.

19. The system of drug dispense and inspection as claimed in claim 12, wherein the database can read, further identify and store the patient information on the prescription; the drug information on the prescription and the drug data which are consistent through comparing with the drug information can be stored together with the patient data.
